(19) United States
(12) Patent Application Publication
(10) Pub. No.: US 2025/0203307 A1
(43) Pub. Date: Jun. 19, 2025

(54) ELECTRONIC DEVICE FOR PHOTOGRAPHING MOVING IMAGE, OPERATING METHOD THEREOF, AND STORAGE MEDIUM

(71) Applicant: Samsung Electronics Co., Ltd., Suwon-si (KR)

(72) Inventor: Sujung KIM, Suwon-si (KR)

(21) Appl. No.: 19/062,634

(22) Filed: Feb. 25, 2025

Related U.S. Application Data
(63) Continuation of application No. PCT/KR2023/009269, filed on Jun. 30, 2023.

(30) Foreign Application Priority Data
Aug. 31, 2022 (KR) 10-2022-0109681
Sep. 28, 2022 (KR) 10-2022-0123748

(51) Int. Cl. H04R 29/00

(52) U.S. Cl. CPC H04R 29/001; H04R 29/004; H04R 2499/11

(57) ABSTRACT

An electronic device is provided. The electronic device includes at least one microphone, at least one speaker, a display, memory storing one or more computer programs, and one or more processors communicatively coupled to the microphone, the speaker, the display, and the memory, wherein the one or more computer programs include computer-executable instructions that, when executed by the one or more processors individually or collectively, cause the electronic device to output a reference sound through the at least one speaker in response to reception of a user request for capturing video, obtain an acoustic signal corresponding to the reference sound through the at least one microphone, analyze the obtained acoustic signal, and display information on a normal or abnormal recording state on at least a portion of the display based on a result of the analysis of the obtained acoustic signal.

### CROSS-REFERENCE TO RELATED APPLICATION(S)

This application is a continuation application, claiming priority under 35 U.S.C. § 365 (c), of an International application No. PCT/KR2023/009269, filed on Jun. 30, 2023, which is based on and claims the benefit of a Korean patent application number 10-2022-0109681, filed on Aug. 31, 2022, in the Korean Intellectual Property Office, and of a Korean patent application number 10-2022-0123748, filed on Sep. 28, 2022, in the Korean Intellectual Property Office, the disclosure of each of which is incorporated by reference herein in its entirety.

### BACKGROUND

### 1. Field

The disclosure relates to an electronic device for capturing a video, a method of operating the same, and a storage medium.

### 2. Description of Related Art

As the variety of services and additional functions provided through electronic devices such as smartphones gradually increases, various applications that can be executed on the electronic devices are being developed. In addition, the hardware and/or software parts of the electronic devices are also continuously being developed.

For example, there are camera applications for capturing videos (e.g., moving images) using a camera mounted on an electronic device, and the number of users capturing videos using the camera applications is increasing. During capturing a video (e.g., image recording or audio recording) using a camera of an electronic device in various environments, not only the video but also sound (or audio) is recorded, and the user may identify the recording status by playing back the recorded video.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for capturing a video, a method of operating the same, and a storage medium.

Additional aspects will be set forth in part in the description which follows and, in part, will be apparent from the description, or may be learned by practice of the presented embodiments.

In accordance with an aspect of the disclosure, an electronic device is provided. The electronic device includes at least one microphone, at least one speaker, a display, memory storing one or more computer programs, and one or more processors communicatively coupled to the microphone, the speaker, the display, and the memory, wherein the one or more computer programs include computer-executable instructions that, when executed by the one or more processors individually or collectively, cause the electronic device to output a reference sound through the at least one speaker in response to reception of a user request for capturing a video, obtain an acoustic signal corresponding to the reference sound through the at least one microphone, analyze the obtained acoustic signal, and display information on a normal or abnormal recording status on at least a portion of the display based on a result of the analysis of the obtained acoustic signal.

In accordance with another aspect of the disclosure, a method of capturing video, performed by an electronic device is provided. The method includes outputting a reference sound through at least one speaker in response to reception of a user request for capturing a video, obtaining an acoustic signal corresponding to the reference sound through at least one microphone, analyzing the obtained acoustic signal, and displaying information on a normal or abnormal recording state based on a result of the analyzing of the obtained acoustic signal.

In accordance with another aspect of the disclosure, one or more non-transitory computer-readable storage media storing one or more computer programs including computer-executable instructions that, when executed by one or more processors of an electronic device individually or collectively, cause an electronic device to perform operations are provided. The operations include outputting a reference sound through at least one speaker in response to reception of a user request for capturing a video, obtaining an acoustic signal corresponding to the reference sound through at least one microphone, analyzing the obtained acoustic signal, and displaying information on a normal or abnormal recording state based on a result of the analysis of the obtained acoustic signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a diagram illustrating an example of an electronic device according to an embodiment of the disclosure;

FIG. 2B is a diagram illustrating an example of an electronic device according to an embodiment of the disclosure;

FIG. 3 is a diagram illustrating an abnormal recording situation according to an embodiment of the disclosure;

FIG. 4 is an internal block diagram illustrating an electronic device according to an embodiment of the disclosure;

FIG. 5 is an operational flowchart illustrating an electronic device for capturing a video according to an embodiment of the disclosure;

FIG. 6 is an operational flowchart illustrating an electronic device when starting to capture a video according to an embodiment of the disclosure;

FIG. 7 is a diagram illustrating a method of identifying a recording situation using a reference sound through a microphone according to an embodiment of the disclosure;

FIG. 8 is a diagram illustrating a screen indicating an abnormal recording situation according to an embodiment of the disclosure;

FIG. 9 is an operational flowchart illustrating an electronic device for identifying an abnormal recording situation during capturing a video according to an embodiment of the disclosure; and

FIG. 10 is a diagram illustrating a screen indicating an abnormal microphone position according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

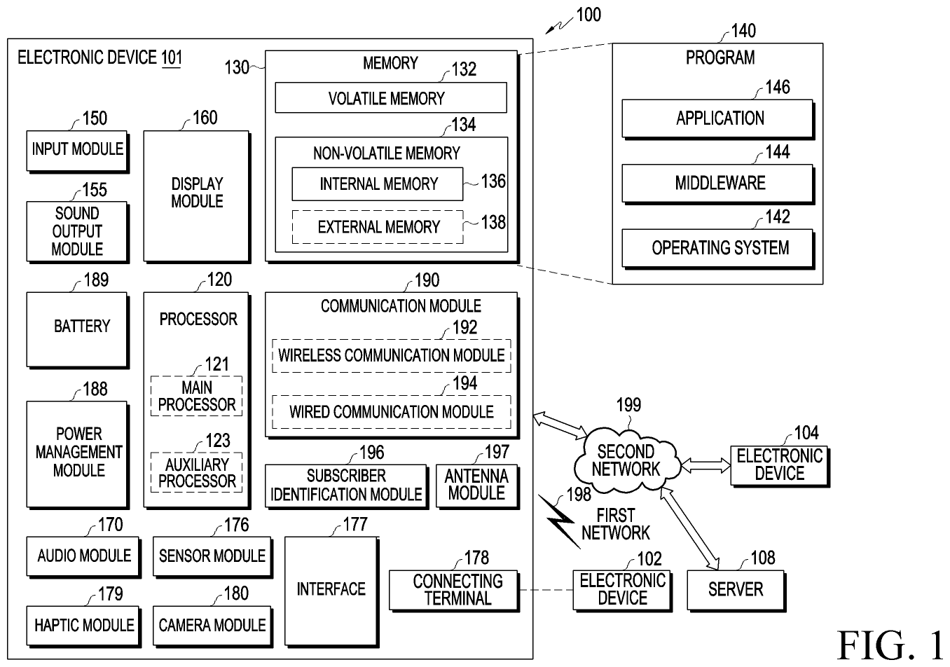

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

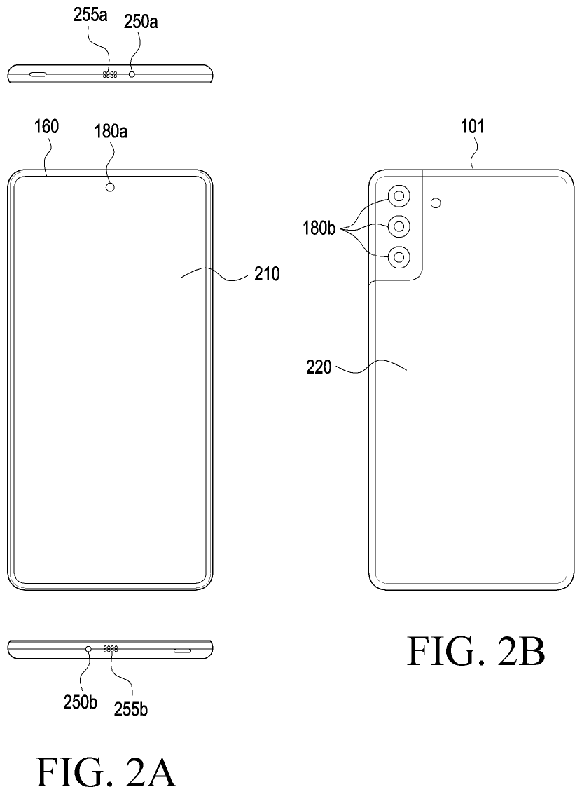

FIGS. 2A and 2B are diagrams illustrating an example of an electronic device according to various embodiments of the disclosure.

Referring to FIGS. 2A and 2B, an electronic device 101 according to an embodiment may be configured such that a display module 160 is arranged so that a display panel is exposed on a first side (e.g., a front side) 210 of a housing, and cameras (e.g., a front camera 180a and a rear camera 180b) included in a camera module 180 are arranged on a portion of the first side and a portion of a second side (e.g., a rear side) 220 of the housing, respectively. For example, the surface on which the display is arranged (or the surface on which the display module 160 is visible from the outside of the electronic device 101) may be defined as the front surface of the electronic device 101. A surface opposite to the front surface may be defined as the rear surface of the electronic device 101. In addition, a surface surrounding a space between the front surface and the rear surface may be defined as the side surface of the electronic device 101.

According to an embodiment, the electronic device 101 may be configured to arrange at least one microphone 250a or 250b on a third surface (e.g., upper side surface) or a fourth surface (e.g., lower side surface) of the housing, respectively. According to an embodiment, the electronic device 101 may include at least one speaker 255a or 255b. As illustrated in FIG. 2A, the at least one speaker 255a or 255b may be arranged on the third surface (e.g., upper side surface) or the fourth surface (e.g., lower side surface) of the housing of the electronic device 101. For example, the at least one speaker 255a or 255b may be arranged adjacent to the at least one microphone 250a or 250b.

In an embodiment, the at least one speaker 255a or 255b is arranged on the side surface in the embodiment illustrated in FIG. 2A, but is not limited thereto, and the at least one speaker 255a or 255b or a speaker not illustrated may be provided as another separate structure and arranged at both edges of a combined or assembled structure or the electronic device 101. In this manner, the at least one speaker 255a or 255b may be designed to be included in the structure of the electronic device 101 depending on the appearance and the usage state thereof.

In FIG. 2A, two microphones and two speakers are arranged at the top or bottom, respectively, but the positions or numbers of the microphones and speakers may not be limited thereto.

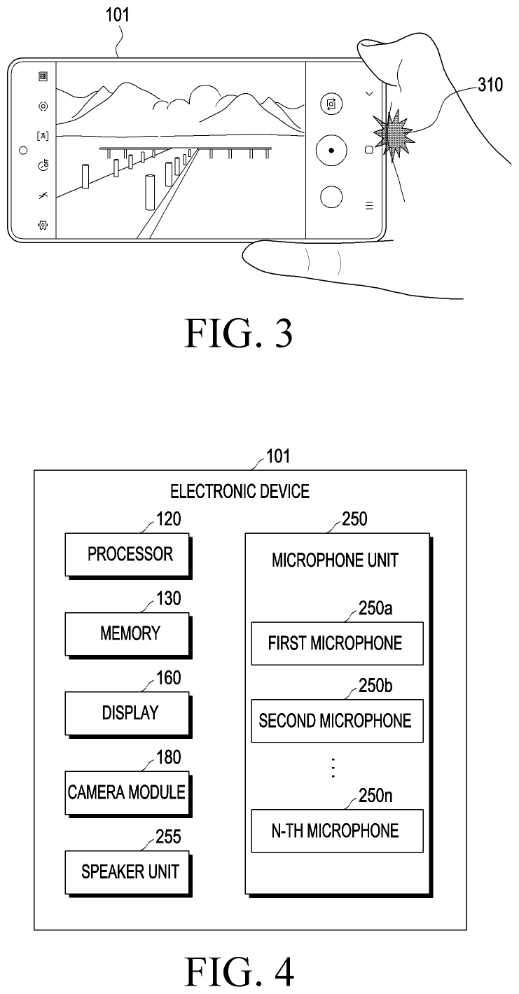

FIG. 3 is a diagram illustrating an abnormal recording situation according to an embodiment of the disclosure.

FIG. 3 illustrates a situation (or state) in which a user performs capturing a video using the electronic device 101. As illustrated in FIG. 3, when the user holds the electronic device 101 by hand so that the camera of the electronic device 101 is directed toward a subject for capturing the video and a recording start button is pressed by the user, the electronic device 101 may store the video output from the cameras (e.g., the front camera 180a and the rear camera 180b) included in the camera module.

For example, during capturing a video (recording or capturing) using the camera of the electronic device 101, not only the video but also sound (or audio) is recorded, and the user may identify the recording status by playing back the recorded video. However, when the microphone is covered depending on where the user holds the electronic device during capturing the video, recording may proceed without accounting for such a situation, which may result in difficulty in obtaining the sound.

According to an embodiment, information on the recording situation may be provided to the user during capturing the video in the electronic device 101. Accordingly, the user may capture the video while identifying whether the recording situation is normal during capturing the video, thereby increasing user convenience.

For example, when the user captures the video while holding a portion of the electronic device 101 by hand, the at least one microphone 250a or 250b arranged on the electronic device 101 may be partially covered depending on a position 310 where the user holds the electronic device 101. In this case, even if the video of the subject is recorded normally, the surrounding sound including the sound emitted by the subject may not be recorded normally. In addition, normal recording may be difficult when the at least one microphone 250a or 250b is partially blocked by a foreign substance. In this manner, when sound is not obtained through the at least one microphone 250a or 250b during capturing the video, the surrounding situation during capturing the video may not be accurately recorded. In this case, the user may identify that the recording is abnormal only after the capturing the video is terminated.

Therefore, when the user can identify whether the normal or abnormal recording is in progress while capturing the video, user convenience can be increased.

In the detailed description below, reference numerals of drawings may be given the same or omitted for components that can be easily understood through the preceding embodiments, and detailed descriptions thereof may also be omitted. The electronic device 101 according to an embodiment disclosed in this document may be implemented such that components of different embodiments are selectively combined, and a component of one embodiment may be replaced by a component of another embodiment. For example, it should be noted that the disclosure is not limited to a specific drawing or embodiment.

FIG. 4 is an internal block diagram illustrating an electronic device according to an embodiment of the disclosure.

Referring to FIG. 4, the electronic device 101 may include at least one processor 120, a memory 130, a display 160, a camera module 180, a microphone unit 250, and/or a speaker unit 255. The electronic device 101 of FIG. 4 may be the electronic device 101 of FIG. 1. Here, not all components illustrated in FIG. 4 are essential components of the electronic device 101, and the electronic device 101 may be implemented by more or fewer components than the components illustrated in FIG. 4. In describing the electronic device 101 of FIG. 4, a detailed description may be omitted for components that are similar to the embodiment of FIG. 1 or can be easily understood through the embodiment of FIG. 1.

Referring to FIG. 4, according to an embodiment, the processor 120 may be electrically connected to the memory 130, the display 160, the camera module 180, the microphone unit 250, and the speaker unit 255.

According to an embodiment, the speaker unit 255 may receive an electric signal from the processor 120, generate sound, and output the generated sound to the outside.

According to an embodiment, the microphone unit 250 may include a plurality of microphones 250a, 250b, . . . , and 250n. For example, the microphone unit 250 or the electronic device 101 may sense the direction of the sound or detect external sound through the plurality of microphones 250a, 250b, . . . , and 250n. The electronic device 101 or the processor 120 may suppress or remove noise based on the external sound detected by the microphone unit 250. For example, the processor 120 may attenuate sound other than multimedia sound or call sound output by the speaker unit 255 based on the external sound detected by the microphone unit 250. In a voice call mode, at least one of the plurality of microphones 250a, 250b, . . . , and 250n may collect the user's voice. The electronic device 101 or the processor 120 may improve the call quality in the voice call mode by using the sound collected through the plurality of microphones 250a, 250b, . . . , and 250n to reinforce the user's voice and suppress external sound.

In an embodiment, in a video capturing mode, the at least one of the plurality of microphones 250a, 250b, . . . , and 250n may be activated to receive sound of at least one subject and sound generated around the subject during capturing the video. For example, in the video capturing mode, one of the plurality of microphones 250a, 250b, . . . , and 250n is activated to receive sound of at least one subject and sound generated around the subject during capturing the video. In the video capturing mode, two or more of the plurality of microphones 250a, 250b, . . . , and 250n are activated to receive sound of at least one subject and sound generated around the subject during capturing the video.

According to an embodiment, the processor 120 may control the camera module 180 to be driven when a camera application (e.g., a program or a function) for capturing a video is executed. The processor 120 may identify that there is a request for capturing a video when an input by an execution icon (e.g., an object, a graphic element, a menu, a button, or a shortcut image) (not shown) representing a camera application displayed on a home screen (not shown) of the display module 160, a designated button input, or an input by a designated gesture is received, and execute the camera application.

The processor 120 of the electronic device 101 according to an embodiment may control the camera module 180 including at least one camera (e.g., the front camera 180a and the rear camera 180b of FIGS. 2A and 2B) to activate the at least one camera and perform capturing the video according to the execution of the camera application. The processor 120 may control the display module 160 to display a preview screen during capturing the video. For example, the processor 120 may activate the microphone of the microphone unit 250 (e.g., the microphone (250a, 250b of FIGS. 2A and 2B) to receive an acoustic signal (or audio signal) corresponding to sound generated by the user, sound by the subject, or sound around the subject during capturing the video.

According to an embodiment, the processor 120 may obtain an acoustic signal corresponding to the sound input by the plurality of microphones 250a, 250b, . . . , and 250n activated during capturing the video. For example, the processor 120 may analyze the obtained acoustic signal, and identify normal or abnormal microphones among the plurality of microphones 250a, 250b, . . . , and 250n based on the analysis result.

According to an embodiment, the memory 130 may store an operating system related to the operation of the electronic device 101, and/or a program or at least one application that supports at least one user function executed through the electronic device 101. In an embodiment, the memory 130 may store a program that identifies an abnormal recording state using the acoustic signal collected through the plurality of microphones 250a, 250b, . . . , and 250n. In an embodiment, the memory 130 may store a reference sound used to identify an abnormal recording state. For example, the reference sound is sound output through the speaker unit 255 during capturing the video, and an acoustic signal corresponding to the reference sound may be input to the plurality of microphones 250a, 250b, . . . , and 250n in response to the reference sound output through the speaker unit 255. In an embodiment, the reference sound may be a capturing start sound provided when capturing the video starts, or may be sound in an inaudible frequency band. For example, the sound of the inaudible frequency band may include a sound of a specific frequency band set as a sound that the user cannot perceive, such as a sound above the audible frequency band or a sound of an extremely low frequency band (e.g., a pilot tone). According to an embodiment, a plurality of the reference sounds may be provided to identify independently the plurality of microphones 250a, 250b, . . . , and 250n. For example, the electronic device 101 may be configured to output a first reference sound (e.g., 19 kHz) through a speaker (e.g., 255a of FIG. 2A) positioned on the upper side surface of the electronic device 101, and to output a second reference sound (e.g., 20 kHz) through a speaker (e.g., 255b of FIG. 2A) positioned on the lower side surface thereof.

In an embodiment, the memory 130 may temporarily store, under the control of the processor 120, the acoustic signals collected by the plurality of microphones 250a, 250b, . . . , and 250n at the start of capturing. Here, the temporarily stored acoustic signals may be signals corresponding to the start sound output through the speaker unit 255 input at the same time as the start of capturing, and may be used to detect whether there is an abnormal recording (or a microphone error).

In an embodiment, the memory 130 may temporarily store, in a buffer, the acoustic signals collected periodically or continuously through the plurality of microphones 250a, 250b, . . . , and 250n activated during capturing in a certain unit.

In an embodiment, the memory 130 may store a threshold value (or threshold level) related to an acoustic signal for determining an abnormal recording. For example, the threshold value may be used for comparison with the amplitude of the acoustic signal collected in response to the start of capturing. For example, the threshold value may be used for comparison with the amplitude of the acoustic signal obtained through the plurality of microphones 250a, 250b, . . . , and 250n. The processor 120 may identify the normal or abnormal recording state based on the result of comparing the amplitude of the obtained acoustic signal with the threshold value.

In an embodiment, the memory 130 may store the characteristics of a default signal corresponding to a reference sound for identifying the normal or abnormal recording state. For example, the memory 130 may store the characteristics (or patterns) of the acoustic signal corresponding to the capturing start sound provided when capturing the video starts. In an embodiment, the memory 130 may store the characteristics (or patterns) of the acoustic signal corresponding to the reference sound of the inaudible frequency band when the capturing start sound is not set, for example, when the electronic device 101 is set to be silent. The pattern of the acoustic signal may mean a change in the signal size by frequency.

For example, the memory 130 may store the pattern of the acoustic signal (or a default signal) for identifying the normal or abnormal recording state, and may be used to compare the stored pattern of the acoustic signal with the pattern of the acoustic signal obtained through the plurality of microphones 250a, 250b, . . . , and 250n at the start of capturing or during capturing. For example, the pattern of the acoustic signal corresponding to the capturing start sound provided at the start of capturing the video and the pattern of the acoustic signal corresponding to the reference sound of the inaudible frequency band may be different from each other. For example, the pattern (or reference pattern) of the acoustic signal that serves as a reference for identifying the normal or abnormal recording state at the start of capturing and the pattern (or reference pattern) of the acoustic signal that serves as a reference for identifying the normal or abnormal recording state during capturing may also be different from each other.

In an embodiment, the processor 120 may analyze the acoustic signal obtained (or received) through the plurality of microphones 250a, 250b, . . . , and 250n. For example, the processor 120 may compare the amplitude of the obtained acoustic signal with the threshold value through analysis of the obtained acoustic signal. Based on the result of comparing the amplitude of the acoustic signal with the threshold value, the processor 120 may identify the normal or abnormal recording state.

In an embodiment, the processor 120 may convert the acoustic signal into a frequency band, and compare the pattern of the acoustic signal converted into the frequency band with the reference pattern stored in the memory 130. Based on the result of comparing the pattern of the acoustic signal with the reference pattern, the processor 120 may identify the normal or abnormal recording state.

The processor 120 according to an embodiment may display information on the normal or abnormal recording state on the display 160 during capturing the video. For example, the processor 120 may display an object indicating the normal or abnormal microphone on at least a portion of the display 160. The processor 120 may display the object (e.g., a graphic element, a function, or an indicator) indicating the normal or abnormal microphone on a portion of the preview screen during capturing the video.

According to an embodiment as described above, by displaying information related to normal or abnormal recording on a video capturing screen when the capturing the video starts or during capturing the video, the user may identify in real time whether the recording is being performed normally. In addition, when recording is not performed normally, the user may recognize the abnormal recording situation, change the state of holding the electronic device 101, or identify whether there is a foreign substance in the microphone. In addition, by displaying the object indicating the microphone, the user may also identify the position of the microphone in the abnormal state, thereby improving convenience during capturing the video.

According to an embodiment, the electronic device 101 is provided. The electronic device includes at least one microphone 250, at least one speaker 255, a display 160, memory storing one or more computer programs, and one or more processors 120 communicatively coupled to the microphone, the speaker, the display, and the memory, wherein the one or more computer programs include computer-executable instructions that, when executed by the one or more processors individually or collectively, cause the electronic device to output a reference sound through the at least one speaker in response to reception of a user request for capturing a video, obtain an acoustic signal corresponding to the reference sound through the at least one microphone, analyze the obtain acoustic signal, and display information on a normal or abnormal recording state on at least a portion of the display based on a result of the analysis of the obtained acoustic signal.

According to an embodiment, the reference sound may be a capturing start sound provided when capturing the video starts or a sound in an inaudible frequency band.

According to an embodiment, the one or more computer programs further include computer-executable instructions that, when executed by the one or more processors individually or collectively, cause the electronic device to identify whether the electronic device is set to be silent, and output, when the electronic device is set to be silent, the sound in the inaudible frequency band through the at least one speaker.

According to an embodiment, the one or more computer programs further include computer-executable instructions that, when executed by the one or more processors individually or collectively, cause the electronic device to output the capturing start sound through the at least one speaker in response to the reception of the user request for capturing the video, when the electronic device is not set to be silent.

According to an embodiment, the one or more computer programs further include computer-executable instructions that, when executed by the one or more processors individually or collectively, cause the electronic device to compare an amplitude of the obtained acoustic signal with a threshold value through analysis of the obtained acoustic signal, and identify the normal or abnormal recording state based on a result of the comparison.

According to an embodiment, the one or more computer programs further include computer-executable instructions that, when executed by the one or more processors individually or collectively, cause the electronic device to display information on the abnormal recording state on at least a portion of the display when the amplitude of the obtained acoustic signal is smaller than the threshold value through the analysis of the obtained acoustic signal.

According to an embodiment, the one or more computer programs further include computer-executable instructions that, when executed by the one or more processors individually or collectively, cause the electronic device to identify whether there is an acoustic signal less than or equal to the threshold value among the acoustic signals obtained through the at least one microphone, identify a microphone that obtained the acoustic signal less than or equal to the threshold value in response to the acoustic signal less than or equal to the threshold value, and display information on the abnormal recording state that guides a position of the identified microphone on at least a portion of the display.

According to an embodiment, the one or more computer programs further include computer-executable instructions that, when executed by the one or more processors individually or collectively, cause the electronic device to obtain an acoustic signal through the at least one microphone during capturing the video, and display information on the normal or abnormal recording state on the at least a portion of the display based on the result of the analysis of the acoustic signal obtained through the at least one microphone.

According to an embodiment, the one or more computer programs further include computer-executable instructions that, when executed by the one or more processors individually or collectively, cause the electronic device to compare amplitudes of acoustic signals obtained through the at least one microphone during capturing the video, identify whether a difference greater than or equal to a designated value occurs based on the result of the amplitude comparison between the acoustic signals, output sound in the inaudible frequency band through the at least one speaker in response to the difference greater than or equal to the designated value, obtain an acoustic signal corresponding to the sound in the inaudible frequency band through the at least one microphone, and display information on the normal or abnormal recording state on at least a portion of the display based on the result of the analysis of the obtained acoustic signal.

According to an embodiment, the one or more computer programs further include computer-executable instructions that, when executed by the one or more processors individually or collectively, cause the electronic device to display a message indicating the abnormal recording state on at least a portion of the display in response to the acoustic signal less than or equal to the threshold value among acoustic signals obtained through the at least one microphone.

According to an embodiment, the one or more computer programs further include computer-executable instructions that, when executed by the one or more processors individually or collectively, cause the electronic device to compare the amplitudes of the acoustic signals obtained through the at least one microphone during capturing the video, identify whether a difference greater than or equal to a designated value occurs based on the result of the amplitude comparison between the acoustic signals, output sound in the inaudible frequency band through the at least one speaker in response to the difference greater than or equal to the designated value, obtain an acoustic signal corresponding to the sound in the inaudible frequency band through the at least one microphone, and display information on the normal or abnormal recording state on at least a portion of the display based on the result of the analysis of the obtained acoustic signal.

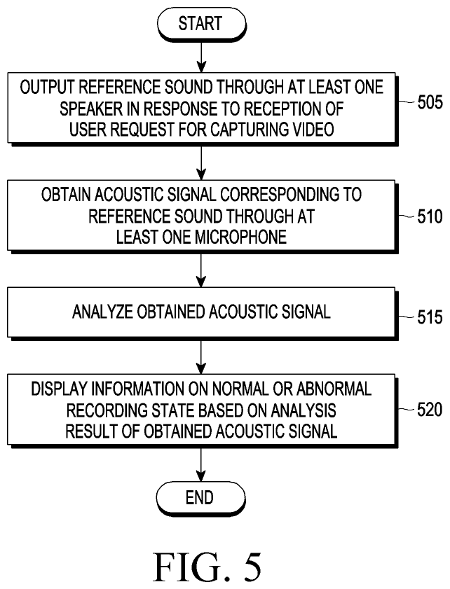

FIG. 5 is an operational flowchart illustrating an electronic device for capturing a video according to an embodiment of the disclosure.

Referring to FIG. 5, the operation method of the electronic device may include operations 505 to 520. Each operation of the operation method of FIG. 5 may be performed by an electronic device (e.g., the electronic device 101 of FIGS. 1, 2A, 2B, 3, and 4 or at least one processor of the electronic device {e.g., the processor 120 of FIG. 1 or the processor 120 of FIGS. 2A and 2B}). In an embodiment, at least one of operations 505 to 520 may be omitted, the order of some operations may be changed, or another operation may be added.

In operation 505, the electronic device 101 may output a reference sound through at least one speaker (e.g., 255a, 255b of FIG. 2A or speaker unit 255 of FIG. 4) in response to reception of a user request for capturing a video. In an embodiment, the reference sound may be a capturing start sound provided when capturing the video starts, or a sound in an inaudible frequency band.

In operation 510, the electronic device 101 may obtain an acoustic signal corresponding to the reference sound through at least one microphone (e.g., 250a, 250b of FIG. 2A, microphone unit 250 of FIG. 4). In an embodiment, the electronic device 101 may identify whether the electronic device 101 is set to be silent. When the electronic device 101 is set to be silent, the electronic device 101 may output a sound of the inaudible frequency band through the at least one speaker. On the other hand, when the electronic device 101 is not set to be silent, the electronic device 101 may output the capturing start sound through the at least one speaker.

In operation 515, the electronic device 101 may analyze the obtained acoustic signal. According to an embodiment, the electronic device 101 may compare the amplitude of the obtained acoustic signal with a threshold value through analysis of the obtained acoustic signal. Based on a comparison result, the electronic device 101 may identify a normal or abnormal recording state.

In operation 520, the electronic device 101 may display information on the normal or abnormal recording state based on a result of the analysis of the obtained acoustic signal.

According to an embodiment, the electronic device 101 may display the information on the abnormal recording state when the amplitude of the obtained acoustic signal is less than or equal to a threshold value through the analysis of the obtained acoustic signal.

According to an embodiment, the electronic device 101 may identify whether there is an acoustic signal less than or equal to the threshold value among the acoustic signals obtained through the at least one microphone. In response to the acoustic signal less than or equal to the threshold value, the electronic device 101 may identify a microphone that obtained the acoustic signal less than or equal to the threshold value. The electronic device 101 may display information on the abnormal recording state that guides the position of the identified microphone.

According to an embodiment, the electronic device 101 may obtain an acoustic signal through the at least one microphone during capturing the video. The electronic device 101 may display information on the normal or abnormal recording state based on a result of the analysis of the acoustic signal obtained through the at least one microphone.

According to an embodiment, the electronic device 101 may compare the amplitudes of the acoustic signals obtained through the at least one microphone during capturing the video. The electronic device 101 may identify whether a difference greater than or equal to a designated value occurs based on the result of the amplitude comparison between the acoustic signals. For example, the electronic device 101 may display information on the normal or abnormal recording state based on the result of the amplitude comparison between the acoustic signals. In an embodiment, the electronic device 101 may output a sound in the inaudible frequency band through the at least one speaker in response to the difference greater than or equal to the designated value. The electronic device 101 may obtain an acoustic signal corresponding to the sound in the inaudible frequency band through the at least one microphone. The electronic device 101 may display the information on the normal or abnormal recording state based on the result of the analysis of the obtained acoustic signal.

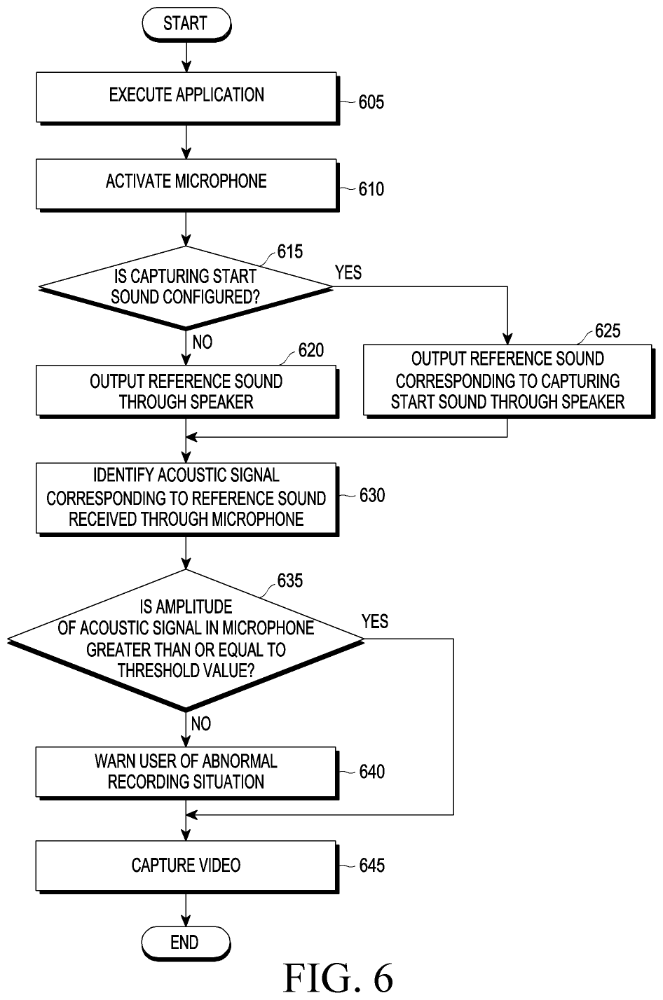

FIG. 6 is an operational flowchart illustrating an electronic device at the start of capturing a video according to an embodiment of the disclosure.

Referring to FIG. 6, the operation method of the electronic device may include operations 605 to 645. Each operation of the operation method of FIG. 6 may be performed by an electronic device (e.g., the electronic device 101 of FIGS. 1, 2A, 2B, 3, and 4 or at least one processor of the electronic device {e.g., the processor 120 of FIG. 1 or the processor 120 of FIGS. 2A and 2B}). In an embodiment, at least one of operations 605 to 645 may be omitted, the order of some operations may be changed, or another operation may be added.

In operation 605, the electronic device 101 may execute an application. The electronic device 101 may display an execution screen of the application. According to an embodiment, the application may be a camera application. According to an embodiment, the execution screen of the application may include a preview area that displays a video obtained by a camera (e.g., a camera module 180 of FIG. 1 or FIG. 4) in real time. For example, the execution screen of the application may be a video capturing screen, and display a video (e.g., video being recorded or video output as low-resolution continuous image frames before capturing the video) being captured as the execution screen displayed on the display 160. According to an embodiment, the execution screen of the application may include an area that displays detailed information corresponding to the preview. For example, the detailed information corresponding to the preview may include capturing information, and the execution screen may display objects (e.g., options, menus, graphic elements, functions, or shortcut icons) related to a configuration to be used at the time of capturing the video.

When a recording button displayed on the video capturing screen is selected, the electronic device 101 may record the video being captured, and in operation 610, the electronic device 101 may activate the microphone to store an acoustic signal received through the microphone together with the video during recording. Here, the recorded video may be a video of continuous image frames.

In operation 615, the electronic device 101 may identify whether a capturing start sound is configured. For example, the capturing start sound may be a sound that guides the start of capturing when a recording button is selected after the application is executed.

When the capturing start sound is configured, in operation 625, the electronic device 101 may output a reference sound corresponding to the capturing start sound through the speaker. For example, the electronic device 101 may output the reference sound corresponding to the capturing start sound through each speaker at the same time as the capturing starts.

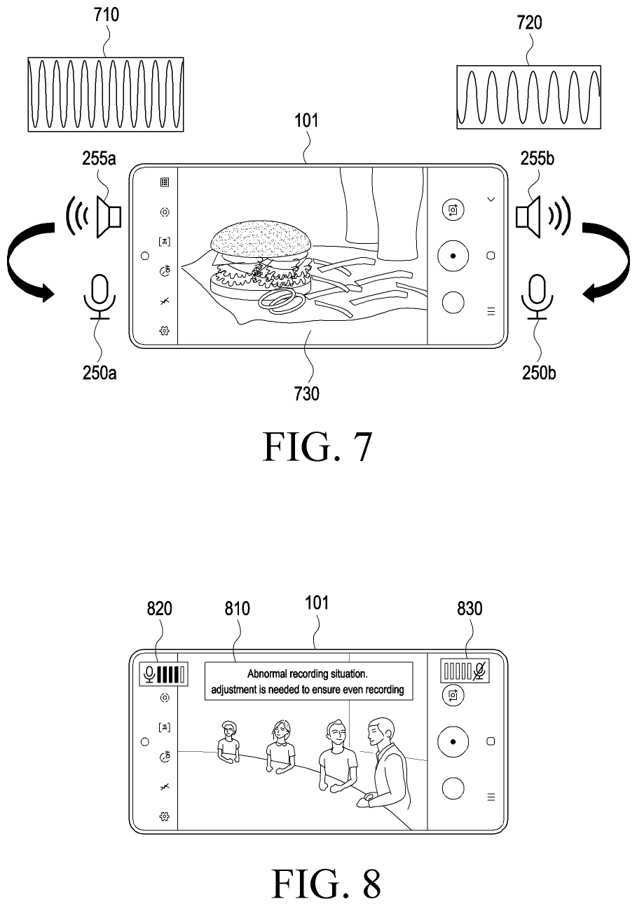

When the capturing start sound is not configured, in operation 620, the electronic device 101 may output the reference sound through the speaker. For example, the case where the capturing start sound is not configured may correspond to the case where the electronic device 101 is configured to be silent. For example, the electronic device 101 may output the reference sound of the inaudible frequency band at the same time as the capturing starts. When the electronic device 101 includes one speaker, the reference sound may be output. For example, when two or more speakers are arranged at different locations in the electronic device 101, the reference sound output through each speaker may be configured differently in consideration of the arrangement locations. In FIG. 7, this will be described in detail.

FIG. 7 is a diagram illustrating a method of identifying a recording situation using a reference sound through a microphone according to an embodiment of the disclosure.

Referring to FIG. 7, a case in which different reference sounds 710 and 720 are output from speakers 255a and 255b while being displayed on a video capturing screen 730 is illustrated. The reference sounds 710 and 720 output from the speakers 255a and 255b may be input through microphones 250a and 250b. The microphones 250a and 250b may obtain acoustic signals corresponding to the reference sounds 710 and 720.

In operation 630, the electronic device 101 may identify the acoustic signal corresponding to the reference sound received through the microphone.

According to an embodiment, when the capturing start sound is output as the reference sound, the electronic device 101 may obtain an acoustic signal corresponding to the capturing start sound through the microphone. For example, the electronic device 101 may analyze the obtained acoustic signal and compare the amplitude of the obtained acoustic signal with a threshold value.

According to an embodiment, when the sound in the inaudible frequency band is output as the reference sound while the electronic device 101 is configured to be silent, the electronic device 101 may obtain the acoustic signal corresponding to the sound in the inaudible frequency band through the microphone.

In operation 635, the electronic device 101 may identify whether the amplitude of the acoustic signal from the activated microphone is greater than or equal to the threshold value. When the amplitude of the acoustic signal from the activated microphone is greater than or equal to the threshold value, the electronic device 101 may capture video in operation 645. In this manner, when the acoustic signal greater than or equal to the threshold value is obtained through each microphone, it can be considered that recording is being performed normally.

On the other hand, when the amplitude of the acoustic signal from the activated microphone is not greater than or equal to the threshold value, the electronic device 101 may warn an abnormal recording situation in operation 640. For example, in a case where there are two activated microphones, the electronic device 101 may warn a user of the abnormal recording situation when the amplitudes of the acoustic signals from the two microphones are not greater than or equal to the threshold value. For example, the electronic device 101 may warn a user of the abnormal recording situation even when the amplitude of the acoustic signal from any one of the activated microphones is not greater than or equal to the threshold value. For example, when the amplitude of the acoustic signal of any one of the activated microphones is smaller than the threshold value, the acoustic signal smaller than the threshold value may be considered to be related to the abnormal recording. For example, it may be considered that a recording error has occurred by the microphone that obtains the acoustic signal smaller than the threshold value among the plurality of microphones 250a, 250b, . . . , and 250n. Accordingly, the electronic device 101 may warn the user of the abnormal recording situation when the abnormal recording situation occurs.

According to an embodiment, the electronic device 101 may control the display 160 to display information indicating the abnormal recording situation on the video capturing screen as shown in FIG. 8.

FIG. 8 is a diagram illustrating a screen that indicates an abnormal recording situation according to an embodiment of the disclosure.

Referring to FIG. 8, the electronic device 101 may display objects (e.g., graphic elements, functions, or indicators) 820 and 830 indicating a normal or abnormal microphone on the video capturing screen. In addition, the electronic device 101 may display information 810 indicating an abnormal recording situation. For example, by displaying the object (e.g., indicator 830) indicating the abnormal microphone, the user can intuitively identify which microphone has a problem.

According to an embodiment, the electronic device 101 may notify the user of the abnormal recording situation through a warning sound or vibration in addition to a warning screen. For example, when the electronic device 101 is held by the user, vibration may be generated at a position corresponding to a microphone that has received an acoustic signal corresponding to the abnormal situation. In this manner, the electronic device may notify the user of the abnormal recording situation by using the object (or graphic element) indicating the amplitude of the acoustic signal received through the activated microphone in relation to the recording situation at the start of capturing the video or during capturing the video.

In a case where the amplitude of the acoustic signal from the activated microphone in operation 635 is greater than or equal to the threshold value, the electronic device 101 may perform capturing the video in operation 645, but perform capturing the video in operation 645 while warning the abnormal recording situation in operation 640. According to an embodiment, the electronic device 101 may continue capturing the video while outputting a notification indicating the abnormal situation even when a warning situation occurs at the start of capturing the video or during capturing the video. For example, the electronic device 101 may output the notification on at least a portion of the preview screen while displaying the preview screen during capturing the video. When the abnormal recording situation is released by the user holding the electronic device 101 again to prevent the microphone from being covered by the user, the electronic device 101 may not display the notification on the preview screen.

Meanwhile, as described above, a method of identifying the microphone status at the start of capturing was described, and in the following, a method of identifying the microphone status periodically or continuously during capturing and notifying the user of the identified microphone status will be described.

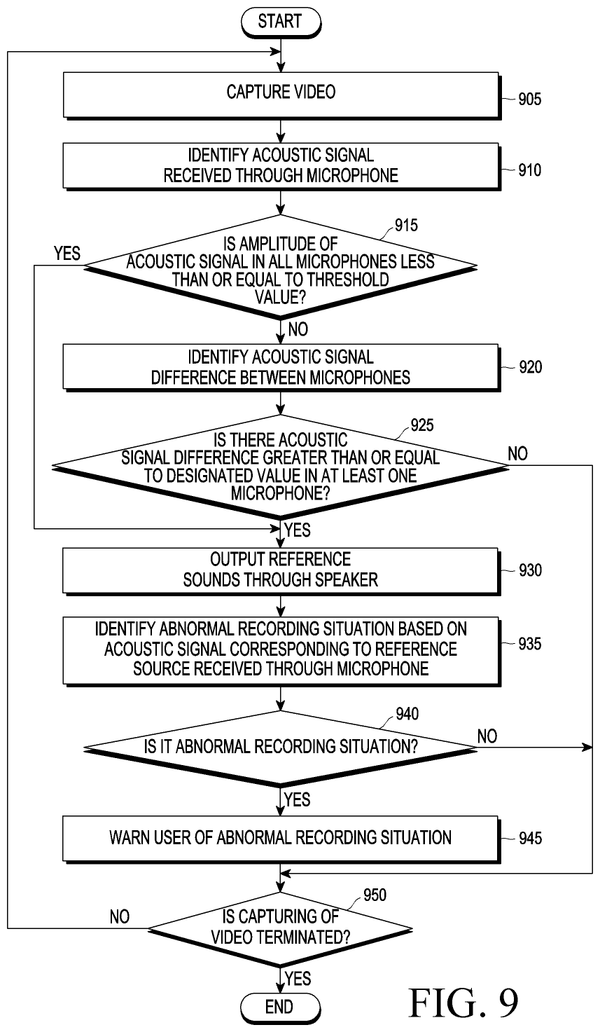

FIG. 9 is an operational flowchart illustrating an electronic device for identifying an abnormal recording situation during capturing a video according to an embodiment of the disclosure.

Referring to FIG. 9, the operation method of the electronic device may include operations 905 to 950. Each operation of the operation method of FIG. 9 may be performed by an electronic device (e.g., the electronic device 101 of FIGS. 1, 2A, 2B, 3, and 4 or at least one processor of the electronic device {e.g., the processor 120 of FIG. 1 or the processor 120 of FIGS. 2A and 2B}). In an embodiment, at least one of operations 905 to 950 may be omitted, the order of some operations may be changed, or another operation may be added.

In operation 905, the electronic device 101 may be in the process of capturing a video. During capturing the video, at least one microphone may be activated to receive an acoustic signal.

In operation 910, the electronic device 101 may identify the acoustic signal received through the microphone. For example, the electronic device 101 may receive the acoustic signal through the at least one microphone activated during capturing the video.

In operation 915, the electronic device 101 may identify whether the amplitude of the acoustic signal from the microphone is less than or equal to the threshold value. For example, the electronic device 101 may identify whether the amplitude of the acoustic signal from all the activated microphones is less than or equal to the threshold value. When the amplitude of the acoustic signal from all the activated microphones is not less than or equal to the threshold value, the electronic device 101 may identify a difference in the acoustic signals between the activated microphones in operation 920. Alternatively, the electronic device 101 may identify the difference in the acoustic signals between the activated microphones in operation 920 even when the amplitude of the acoustic signal from any one of the activated microphones is not less than or equal to the threshold value.

In an embodiment, when the amplitude of the acoustic signal from the microphone is identified as being less than or equal to the threshold value in operation 915, the electronic device 101 may perform operation 930. For example, the electronic device 101 may identify that the amplitude of the acoustic signal from all the activated microphones is less than or equal to the threshold value. For example, when the amplitude of the acoustic signal from all the activated microphones is less than or equal to the threshold value, it may correspond to a very quiet situation. When sound generated by the user and the subject or sound generated by the surroundings of the subject is very small during capturing the video, the amplitude of the acoustic signal obtained through the activated microphone may also be very small. Therefore, when the amplitude of the acoustic signal from all the microphones in the activated state is less than or equal to the threshold value, the electronic device 101 may output a designated reference sound through the speaker in operation 930. For example, it is necessary to determine whether the microphone is abnormal during capturing the video even when the surroundings are very quiet. Therefore, the designated reference sound output through the at least one speaker may be used to identify the microphone status. For example, the reference sound may include a sound in the inaudible frequency band.

By performing the operation of identifying the difference in the acoustic signals between the microphones in the activated state in operation 920, in operation 925, the electronic device 101 may identify whether there is an acoustic signal difference greater than or equal to a designated value in the at least one microphone. For example, depending on the reception sensitivity of the microphone or due to various factors such as a distance from at least one subject or the sound generated by the surroundings of the subject, the at least one microphone among the activated microphones may have an acoustic signal difference compared to other microphones. Therefore, unless the acoustic signal difference greater than or equal to the designated value corresponding to a microphone abnormal situation occurs, for example, the acoustic signal difference less than or equal to the designated value may be ignored, and the electronic device 101 may continuously perform capturing the video.

Accordingly, when it is determined that the acoustic signal difference greater than or equal to the designated value is not identified from the at least one microphone in operation 925, capturing the video may be continuously performed, and the electronic device 101 may identify whether capturing the video is terminated in operation 950. On the other hand, in response to identifying the acoustic signal difference greater than or equal to the designated value from the at least one microphone, in operation 930, the electronic device 101 may output a reference sound from the speaker. For example, when a difference in the acoustic signals between the microphones in the activated state is greater than or equal to the designated value, it is necessary to determine whether such a difference is caused by the surrounding sound or a problem with the microphone.

For example, in a state where the acoustic signal is obtained using the plurality of microphones in the active states, when the difference in the acoustic signals between one microphone and the remaining microphones is greater than or equal to a certain threshold (e.g., about 20 dB), the reference sound of the inaudible frequency band may be output through the at least one speaker to determine whether there is an abnormality in the microphone.

In operation 935, the electronic device 101 may identify an abnormal recording situation based on the acoustic signal corresponding to the reference sound received through the microphone. For example, the electronic device 101 may compare a pattern of the acoustic signal corresponding to the reference sound of the inaudible frequency band with a stored reference pattern, and identify a normal or abnormal recording situation based on the comparison result.

In operation 940, the electronic device 101 may identify whether there is the abnormal recording situation. For example, the electronic device 101 may identify whether the pattern of the acoustic signal corresponding to the reference sound of the inaudible frequency band and the stored reference pattern matches each other completely or by a certain percentage or more based on the comparison result therebetween. In the case of not the abnormal recording situation based on the result of identifying the abnormal recording situation in operation 940, the electronic device 101 may proceed to operation 950 to identify whether capturing the video is terminated. For example, when the user presses a video capturing stop button, capturing the video may be terminated. The electronic device 101 may return to operation 905 and continuously perform capturing the video unless capturing the video is terminated by the user request in operation 950, and repeatedly perform the above-described operations.

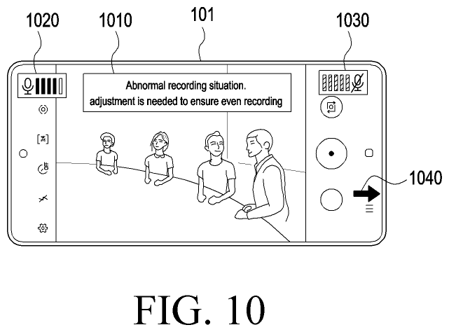

Meanwhile, in the case of the abnormal recording situation based on the result of identifying the abnormal recording situation in operation 940, in operation 945, the electronic device 101 may warn a user of the abnormal recording situation. For example, the electronic device 101 may display a screen indicating the abnormal recording situation as illustrated in FIG. 10.

FIG. 10 is a diagram illustrating a screen indicating an abnormal microphone position according to an embodiment of the disclosure.

Referring to FIG. 10, the electronic device 101 may display objects (e.g., graphic elements, functions, or indicators) 1020 and 1030 indicating a normal or abnormal microphone on the video capturing screen. For example, the object 1030 may be configured in various ways so that the user can recognize the abnormal recording situation at a glance by displaying the object 1030 in a different color or using a blinking scheme. In an embodiment, the electronic device 101 may display information 1010 indicating the abnormal recording situation. In an embodiment, the electronic device 101 may display the object 1040 indicating the position of the microphone in the abnormal state, so that the user can intuitively identify the position of the microphone in which a problem occurred.

In an embodiment, in the case of not the abnormal recording situation, the electronic device 101 may identify whether capturing the video is terminated in operation 950. The electronic device 101 may return to operation 905 in which capturing the video is not terminated in operation 950 and continuously perform the aforementioned capturing the video. According to an embodiment, the operation for identifying the abnormal recording situation may be performed periodically or a designated number of times (e.g., twice).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, in one or more non-transitory storage media storing one or more computer programs including computer-executable instructions that, when executed by one or more processors of an electronic device individually or collectively, cause the electronic device 101 to perform operations, the operations may include outputting a reference sound through at least one speaker in response to reception of a user request for capturing a video, obtaining an acoustic signal corresponding to the reference sound through at least one microphone, analyzing the obtained acoustic signal, and displaying information on a normal or abnormal recording state based on a result of the analysis of the obtained acoustic signal.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one microphone;
at least one speaker;
a display;
memory storing one or more computer programs; and
one or more processors communicatively coupled to the microphone, the speaker, the display, and the memory,
wherein the one or more computer programs include computer-executable instructions that, when executed by the one or more processors individually or collectively, cause the electronic device to:
output a reference sound through the at least one speaker in response to reception of a user request for capturing a video,
obtain an acoustic signal corresponding to the reference sound through the at least one microphone,
analyze the obtain acoustic signal, and
display information on a normal or abnormal recording state on at least a portion of the display based on a result of the analysis of the obtained acoustic signal.

2. The electronic device of claim 1, wherein the reference sound is a capturing start sound provided when capturing the video starts or a sound in an inaudible frequency band.

3. The electronic device of claim 2, wherein the one or more computer programs further include computer-executable instructions that, when executed by the one or more processors individually or collectively, cause the electronic device to:
identify whether the electronic device is set to be silent;
output the sound in the inaudible frequency band through the at least one speaker, when the electronic device is set to be silent; and
output the capturing start sound through the at least one speaker in response to the reception of the user request for capturing the video, when the electronic device is not set to be silent.

4. The electronic device of claim 1, wherein the one or more computer programs further include computer-executable instructions that, when executed by the one or more processors individually or collectively, cause the electronic device to:
compare an amplitude of the obtained acoustic signal with a threshold value through analysis of the obtained acoustic signal; and
identify the normal or abnormal recording state based on a result of the comparison.

5. The electronic device of claim 4, wherein the one or more computer programs further include computer-executable instructions that, when executed by the one or more processors individually or collectively, cause the electronic device to display information on the abnormal recording state on at least a portion of the display when the amplitude of the obtained acoustic signal is smaller than the threshold value through the analysis of the obtained acoustic signal.

6. The electronic device of claim 4, wherein the one or more computer programs further include computer-executable instructions that, when executed by the one or more processors individually or collectively, cause the electronic device to:
identify whether there is an acoustic signal less than or equal to the threshold value among the acoustic signals obtained through the at least one microphone;
identify a microphone that obtained the acoustic signal less than or equal to the threshold value in response to the acoustic signal less than or equal to the threshold value; and
display information on the abnormal recording state that guides a position of the identified microphone on at least a portion of the display.

7. The electronic device of claim 1, wherein the one or more computer programs further include computer-executable instructions that, when executed by the one or more processors individually or collectively, cause the electronic device to:
obtain an acoustic signal through the at least one microphone during capturing the video; and
display information on the normal or abnormal recording state on the at least a portion of the display based on the result of the analysis of the acoustic signal obtained through the at least one microphone.

8. The electronic device of claim 2, wherein the one or more computer programs further include computer-executable instructions that, when executed by the one or more processors individually or collectively, cause the electronic device to:
compare amplitudes of acoustic signals obtained through the at least one microphone during capturing the video;
identify whether a difference greater than or equal to a designated value occurs based on the result of the amplitude comparison between the acoustic signals;
output sound in the inaudible frequency band through the at least one speaker in response to the difference greater than or equal to the designated value;
obtain an acoustic signal corresponding to the sound in the inaudible frequency band through the at least one microphone; and
display information on the normal or abnormal recording state on at least a portion of the display based on the result of the analysis of the obtained acoustic signal.

9. The electronic device of claim 4, wherein the one or more computer programs further include computer-executable instructions that, when executed by the one or more processors individually or collectively, cause the electronic device to display a message indicating the abnormal recording state on at least a portion of the display in response to the acoustic signal less than or equal to the threshold value among acoustic signals obtained through the at least one microphone.

10. A method of capturing video, performed by an electronic device, the method comprising:
outputting a reference sound through at least one speaker in response to reception of a user request for capturing a video;
obtaining an acoustic signal corresponding to the reference sound through at least one microphone;
analyzing the obtained acoustic signal; and
displaying information on a normal or abnormal recording state based on a result of the analyzing of the obtained acoustic signal.

11. The method of claim 10, wherein the reference sound is a capturing start sound provided when capturing the video starts or a sound in an inaudible frequency band.

12. The method of claim 11, wherein the outputting of the reference sound through the at least one speaker comprises:
identifying whether the electronic device is set to be silent;
outputting the sound in the inaudible frequency band through the at least one speaker, when the electronic device is set to be silent; and
outputting the capturing start sound through the at least one speaker in response to the reception of the user request for capturing the video, when the electronic device is not set to be silent.

13. The method of claim 10, wherein the analyzing of the obtained acoustic signal comprises:
comparing an amplitude of the obtained acoustic signal with a threshold value through analysis of the obtained acoustic signal; and
identifying the normal or abnormal recording state based on a result of the comparing.

14. The method of claim 13, further comprising:
identifying whether there is an acoustic signal less than or equal to the threshold value among the acoustic signals obtained through the at least one microphone;
identifying a microphone that obtained the acoustic signal less than or equal to the threshold value in response to the acoustic signal less than or equal to the threshold value; and
displaying information on the abnormal recording state that guides a position of the identified microphone.

15. The method of claim 13, further comprising:
displaying information on the abnormal recording state on at least a portion of the display when the amplitude of the obtained acoustic signal is smaller than the threshold value through the analysis of the obtained acoustic signal.

16. The method of claim 10, further comprising:
obtaining an acoustic signal through the at least one microphone during capturing the video; and
displaying information on the normal or abnormal recording state on the at least a portion of the display based on the result of the analysis of the acoustic signal obtained through the at least one microphone.

17. The method of claim 11, further comprising:
comparing amplitudes of acoustic signals obtained through the at least one microphone during capturing the video;
identifying whether a difference greater than or equal to a designated value occurs based on the result of the amplitude comparison between the acoustic signals;
outputting sound in the inaudible frequency band through the at least one speaker in response to the difference greater than or equal to the designated value;
obtaining an acoustic signal corresponding to the sound in the inaudible frequency band through the at least one microphone; and
displaying information on the normal or abnormal recording state on at least a portion of the display based on the result of the analysis of the obtained acoustic signal.

18. The method of claim 13, further comprising displaying a message indicating the abnormal recording state on at least a portion of the display in response to the acoustic signal less than or equal to the threshold value among acoustic signals obtained through the at least one microphone.

19. One or more non-transitory computer-readable storage media storing one or more computer programs including computer-executable instructions that, when executed by one or more processors of an electronic device individually or collectively, cause an electronic device to perform operations, the operations comprising:
outputting a reference sound through at least one speaker in response to reception of a user request for capturing a video,
obtaining an acoustic signal corresponding to the reference sound through at least one microphone,
analyzing the obtained acoustic signal, and
displaying information on a normal or abnormal recording state based on a result of the analysis of the obtained acoustic signal.

20. The one or more non-transitory computer-readable storage media of claim 19, the operations further comprising:
identifying whether the electronic device is set to be silent;
outputting the sound in an inaudible frequency band through the at least one speaker, when the electronic device is set to be silent; and
outputting a capturing start sound through the at least one speaker in response to reception of the user request for capturing the video, when the electronic device is not set to be silent.
